(19) United States
(12) Patent Application Publication
(10) Pub. No.: US 2009/0244741 A1
(43) Pub. Date: Oct. 1, 2009

(54) SYSTEM, APPARATUS AND METHOD FOR ACTIVE MIRRORS WITH BLIND SPOT DETECTION

(75) Inventors: Steven Yellin Schondorf, Dearborn, MI (US); Kristin Marie Schondorf, Dearborn, MI (US)

Correspondence Address: RADER, FISHMAN & GRAUER PLLC;FORD GLOBAL TECHNOLOGIES, INC., 39533 WOODARD AVENUE, SUITE #140, BLOOMFIELD HILLS, MI, 48304, US

(73) Assignee: FORD GLOBAL TECHNOLOGIES, LLC., Dearborn, MI (US)

(21) Appl. No.: 12/059,267

(22) Filed: Mar. 31, 2008

(51) Int. Cl. G02B 7/198

(52) U.S. Cl. 359/843

(57) ABSTRACT

A system, apparatus and method to automatically move a side mounted mirror on a vehicle from an inward position to an outward position in response to a signal from a detector indicative of an object outside an operator normal field of vision. The detector may be a blind spot detection system or a lane departure system, or any other system to detect vehicles in a blind spot. The system, apparatus and method further includes permitting an operator to manually actuate the movement of mirror on a vehicle to determine whether there are any objects in the operator's normal field of vision. The systems and method may optionally include hysteresis during mirror movement.

### TECHNICAL FIELD

In automotive or other vehicle environments, interior and exterior rearview mirrors can leave blind spots in an operator's field of vision. Blind spot detection systems have been proposed and developed as at least partial solutions to this challenge. In some embodiments, blind spot detectors can utilize a visual indicator, usually in the sideview or rearview mirror itself, or in close proximity thereof, to alert an operator that a vehicle or other object is in the vehicle blind spot. There has been some consideration that the visual indicator may be an annoyance or even a distraction to some vehicle operators. Auditory alarms and haptic alarms indicating an object is in the blind spot may also be perceived by some as a distraction. Thus, customer acceptance of the feature may be less than desired as the annoyance of the warning alert, such as a light in the mirror, an audio or even a haptic alert may cause some customers not to opt for such a blind spot detection system. In addition, there may be a perception that perhaps the warning, such as an audio or haptic signal, or a visual indicator light in the mirror is not entirely reliable to indicate that an object, such as another vehicle, is in the vehicle blind spot.

Some lane departure systems may also detect objects in a vehicle blind spot during vehicle operation that should be brought to the operator's attention. Specifically, when a vehicle is changing lanes or another vehicle is approaching and is in the vehicle blind spot, the lane departure system may indicate an object is in the blind spot by actuating an alarm, such as a light, making a sound, or providing a haptic warning. It is a concern that some vehicle operators may perceive such warnings as a distraction.

There is a need to provide a vehicle operator with an auxiliary system that provides actual visual contact with the object in the blind spot of a vehicle that is inexpensive and reliable.

There is a further need to provide a vehicle operator with an inexpensive way to utilize input from the blind spot detection system and/or a lane departure system, to provide a visual confirmation that an object is or is not in the blind spot so that a vehicle operator may act accordingly.

There is a continuing need for an improved method to detect objects in a vehicle blind spot that reduces operator distraction by permitting actual visual confirmation of the object in the blind spot.

These and other aspects of the invention will become apparent upon a reading of the application and claims.

### SUMMARY OF THE INVENTION

In one embodiment, the present invention relates to a method to automatically move a side mounted mirror on a vehicle from an inward position to an outward position in response to a signal from a detector indicative of an object outside an operator's normal field of vision. The method may comprise;

detecting whether the object is outside the normal field of vision and transmitting a data signal from the detector to a controller indicative of the presence of the object outside the normal field of vision;

actuating at least one servo mechanism responsive to a data signal from the controller to move the mirror outwardly to an outward position from the inward position to permit an operator to view the object that is outside the normal field of vision;

maintaining the mirror in the outward position for a predetermined period of time based upon hysteresis developed by the detector after the object has moved from the detector;

actuating the servo mechanism responsive to a data signal from the controller to move the mirror from the outward position to return to the inward position upon expiration of the predetermined period of time and restore the normal field of vision to the operator.

In another embodiment, the method may include a detector that is a blind spot detection system based upon cameras, radar, lidar, ultrasonic, infrared, or motion detection.

In still another embodiment, the method may include a detector that is a lane departure system based upon cameras, radar, infrared ultrasonic, lidar or motion detection.

In yet another embodiment, the method may include an operator's manual actuation of the mirror movements to effect continuous movement of the mirror to show a wider field of vision to the operator.

In another embodiment, the method may include a full active mode of operation wherein the driver may actuate a switch or toggle to initiate an active mode of operation. The active mode of operation may comprise constantly moving the mirrors from an inward to an outward position to permit the operator to have a field of vision wider than the normal field of vision.

In still another embodiment, the present invention may be directed to a system wherein at least two vehicles are equipped with lane departure or blind spot detection systems, and further equipped with transceivers to transmit and receive signals from one another to cause the mirrors on at least one such vehicle to move outwardly in response to a signal received to provide visual confirmation that an object is in the blind spot of the vehicle.

These and other embodiments will become apparent upon a reading of the application and appended claims, without departing from the scope and spirit of the invention as set forth in the claims.

### BRIEF DESCRIPTION OF THE DRAWINGS

FIG. 1 is a schematic view of at least one of the vehicles in FIG. 2, showing one construction of the active view mirror apparatus of the present invention.

FIG. 2 is a top view of two vehicles equipped with blind spot detection systems, and/or Lane Departure Systems, at least one of which is further equipped with an active mirror system according to one embodiment of the present application.

FIG. 3 is a schematic representation of one embodiment of a system according to the present invention.

FIG. 4. is a software flow chart showing one method for the operation of the active mirror system according to one embodiment of the present invention.

### DETAILED DESCRIPTION OF THE PREFERRED EMBODIMENT(S)

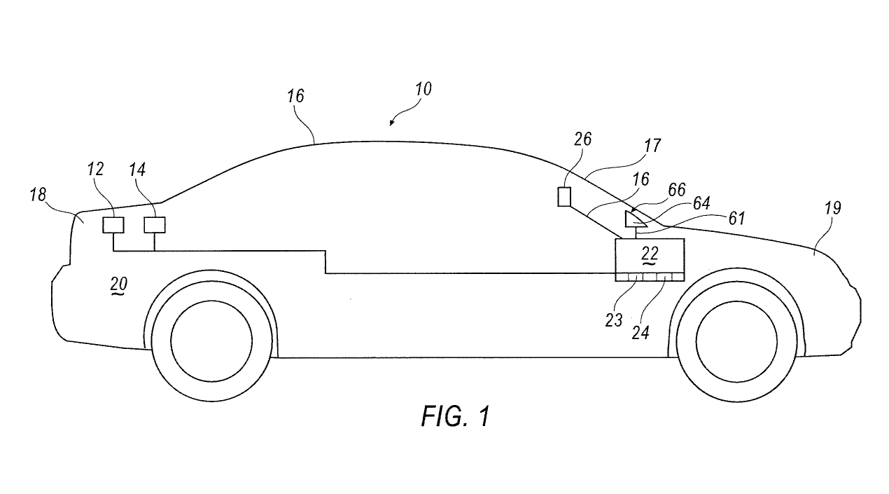

Turning now to the drawings wherein like numbers depict like structures, and particularly to FIG. 1, system 10 is comprised of at least two radar sensors 12, 14, which may be positioned on a host vehicle 16, such that it is in the rear 18 and sides 20 of the vehicle so that any blind spot is under surveillance. While one side of a vehicle is discussed, it is apparent to those skilled in the art that both sides of the vehicle are equipped with identical structures that mirror each other. While a radar based system is discussed it is apparent that a visual or motion detection system could also function as the blind spot detection system. The input from the radar sensors is transmitted to an electronic control module (ECU) 22 with memory 23. The ECU has a memory such as PROM, EPROM, EEPROM, Flash, or any other memory, and various tables are contained therein wherein maximum and minimum ranges are stored. In addition, the ECU may contain look up tables that contain various times for the side view mirror to remain in an outward position that may be operator selectable. Moreover, the ECU may further contain data indicative of vehicle speed, blind spot detection system signal strength, blind spot detection range to target, traffic intensity, turn signal status, and vehicle position in lane. In one embodiment, the Blind Spot Detection System may also include input from a Lane Departure Warning System to assist in continuously determining Maximum Range Limits for the Blind Spot Detection System. In another embodiment, the Lane Departure Warning System may be a vision system usually mounted on the front of the vehicle and oriented to look forward so that the vision sensors can detect lane markers on the road in front of the vehicle. In addition to lane markers, the vision sensors can also detect guard rails, edge of road and any other obstacles in the vehicle path. The vision sensors transmit data to the ECU wherein the lane offset is determined. Lane offset is defined for purposes of this application as the distance between the side of the vehicle and the same side lane markers, perpendicular to the direction of the lane and vehicle travel. The lane offset is continuously computed as the vehicle travels in a lane, and is used to continuously modify the Maximum Range Limit of the radar sensed beam which, if an object is detected within the continuously programmable Maximum Range Limit, an alarm is activated. Specifically, as the radar sensor data are received, the distances to the objects as determined by the radar sensors are compared against the various maximum distances as continuously determined by the lane offset and stored in the tables in the ECU. The ECU continuously computes the distance to an object as perceived by the radar sensor(s) and compares that distance against the maximum range limit as continuously computed by the ECU based upon continuous input from the vision sensor and stored in the tables in the ECU. If an object is determined to be within the maximum range, the ECU sends a signal to an alarm 26 which is electronically connected to the ECU and an operator can be alerted when an object within the maximum range is detected.

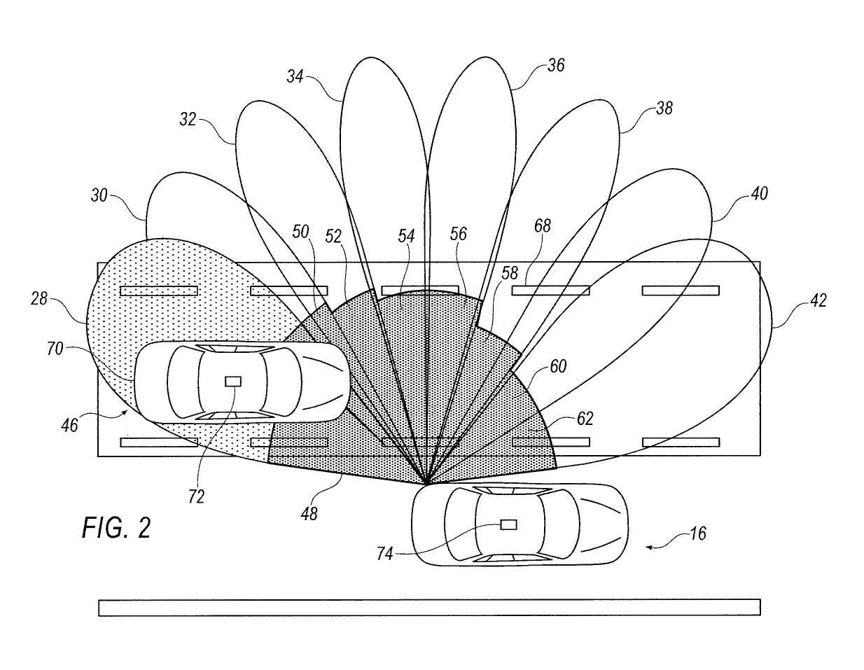

FIG. 2 is a schematic overview representation of a vehicle equipped with the programmable Blind Spot Detection System and/or Lane Departure System of the present invention traveling on a road showing the multiple beams and the limited range of each such beam.

Specifically, host vehicle 16 is shown with at least one radar sensor mounted on the rear and sides of the host vehicle. Those skilled in the art recognize that whereas structures on one side of the vehicle are described, identical structures may be and preferably are mounted on the opposite side of the vehicle. Multiple overlapping radar beams 28, 30, 32, 34, 36, 38, 40 and 42 are shown, emanating from the rear and along the side of the host vehicle to detect oncoming vehicle 44 as it approaches from the rear in an adjacent lane 46. Within each radar beam, continuously programmable Maximum Range Limits 48, 50, 52, 54, 56, 58 and 60 form a sub part of each multiple radar beam, and indicate the Maximum Range Limit as continuously programmed within the ECU for detecting objects in adjacent lanes of traffic in each of the beams. Each continuously programmable Maximum Range Limit is arranged in decreasing order to provide for an overall maximum range limit of the system that will facilitate detection of approaching objects.

In order to calculate the continuously programmable Maximum Range Limit for each of the radar beams, a vision sensor 64 is used such as one would expect with a Lane Departure Warning System 66. The Lane Departure Warning System is a vision based system that uses at least one vision sensor 64, usually located in the front 19 of the vehicle behind the windshield 17 to sense the lane markings 68, guard rails, edge of road or other obstacles. The vision system is electronically connected at 61 to the ECU and continuously senses actual images and transmits the vision data to the ECU which processes the image data such that the Maximum Range Limit is calculated to be no further than the lane markers 68 or guard rails (not shown) of the adjacent lane of traffic. Specifically, the vision sensor may use lane offset and continuously modify the Maximum Range Limit of the radar sensors of the Blind Spot Detection System. Any radar data beyond the continuously programmable Maximum Range Limits for the radar beams are ignored. As each lane marking, road edge or guard rail image comes into view, the Lane Offset is re-determined, and is processed by the ECU to continuously modify the Maximum Range Limit of the radar beams of the Blind Spot Detection System. The system may further utilize lidar.

In one embodiment of the present invention, the operation of the Blind Spot Detection System may be explained in greater detail. Specifically, as host vehicle travels down a lane, the vision sensors detect the lane markings or guard rails or any other obstacle and continuously transmit such data to the ECU where it is processed and used to continuously modify the Maximum Range Limit of the radar beams of a Blind Spot Detection System. An object, such as vehicle 70 approaching a blind spot in the adjacent lane, is detected as a possible warning event when it enters into a beam, and intrudes into the maximum range limit and is detected as coming closer to the vehicle as it impinges within the maximum range area of the beams. As the vehicle 70 approaches the host vehicle, a determination is made whether the vehicle is a potential warning event. When it is determined that the distance between the vehicle and the host vehicle becomes shorter than a predetermined distance, the alarm is activated and the host vehicle operator is warned. Once the radar sensor indicates that the distance between the host vehicle and the perceived object has increased such that the perceived object is outside of the continuously programmable Maximum Range Limit, the alarm is deactivated. Those skilled in the art understand that the object may also be pedestrians, guard rails, debris, approaching vehicles in the same or an adjacent lane as the host vehicle, or any other object that may pose a potential hazard to the host vehicle. The system, as described, is further disclosed in pending U.S. patent application Ser. No. 11/786,244 filed Apr. 11, 2007, entitled “System and Method of Modifying Programmable Blind Spot Detection Sensor Ranges with Vision Input” and assigned to the assignee of the present application each incorporated herein by referenced in its entirety.

The vehicles as described in FIG. 2 are equipped with transceivers 72, 74 respectfully, which transmit and receive signals to/from other similarly equipped vehicles, alerting them of their presence in a blind spot of a host vehicle. However detected, once an object is determined to be in a vehicle blind spot, a data signal indicative that a vehicle or other object is in another vehicle's blind spot is transmitted to a controller, which may be in the side view mirror unit or may be the vehicle ECU.

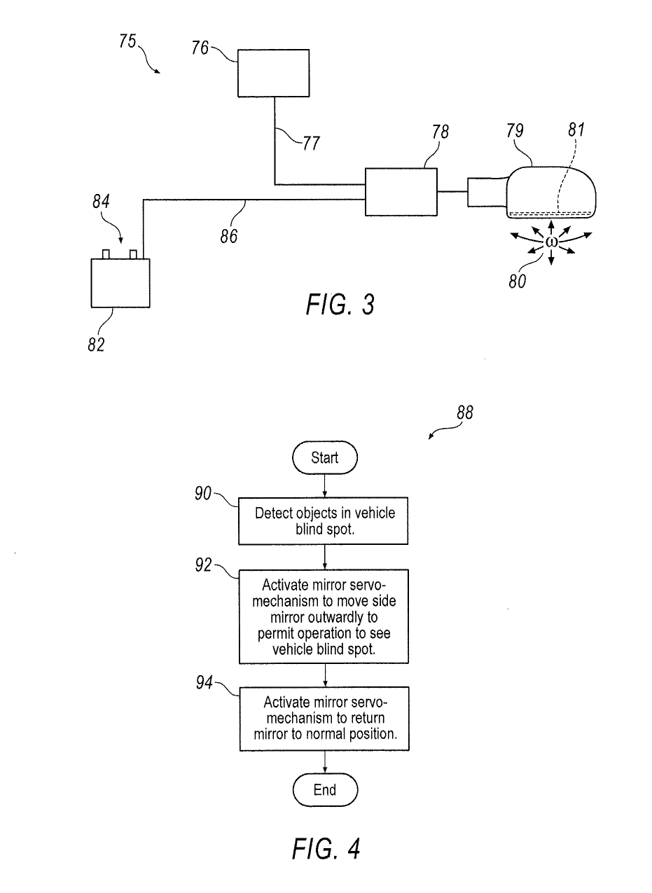

FIG. 3 is a schematic representation of a system according to one embodiment of the present application. Specifically, system 75 is comprised of a controller 76 that receives signals from the Blind Spot Detection System, Lane Departure Detection system, and/or the transceiver indicative of whether an object or other vehicle is in the vehicle blind spot. The controller is electrically connected at 77 to a servo mechanism 78, which may be an electric motor with a screw type drive to rotate mirror 81 an appropriate direction 80 within the housing of the mirror and back to a normal position in response to data signal inputs indicative of whether a vehicle or other object is in the vehicle blind spot. Specifically, a determination is made in the controller 76 that a vehicle or other object is in the vehicle blind spot and a command from the controller to a mirror servo mechanism, such as a motor 78, is made, causing the servo mechanism to move the mirror angularly outwardly within the mirror housing 79 an appropriate angular distance 80 to permit the vehicle operator to visually confirm that an object is in the vehicle blind spot. In other words, the mirror is rotated outwardly from its normal position so that the operator's field of view is changed, and the mirror is now reflective of a field of view outside the normal field of view of the operator, It is contemplated in the present invention that the outward position of the mirror may be a programmable event, based upon specific occupant input, much as a normal vehicle mirror position may be programmed based upon a specific vehicle occupant input. In another embodiment, the outward mirror position may be a fixed angular position outward from the vehicle side to permit operator viewing of the vehicle blindspot. The angle may further be a function of the inward position setting. The mirror will preferably remain in an outward position permitting the operator to see an object in the vehicle blind spot as long as the object is in the blind spot, and will return to the normal position and restore a normal field of vision to the operator once the object has passed out of the vehicle blind spot. It contemplated that the mirror movement may be a fixed angular rotation or a variable angular rotation. Those skilled in the art recognize that any mechanism that will move the mirrors outwardly and inwardly is contemplated in this invention, and the disclosure is not to be limited to the single embodiment discussed.

The system and apparatus of the present invention further includes providing for a control 82 in the vehicle compartment to permit the operator of the vehicle to control the outward and inward movement of the side view with a single switch actuation to permit the operator to check the blind spots of the vehicle at any time of his/her choosing. Specifically, the control may be switch 84 in the vehicle compartment that is electrically connected at 86 to the servo mechanism in the mirror to permit the operator to select whether to rotate the mirrors outwardly or inwardly.

In another embodiment, the mirrors may be programmed to move a single event, periodically (or continuously) from an inward to an outward position and back to allow views of the blind spots. Such a feature could permit the operator to view the blind spots of the host vehicle with a manual actuation of a switch, or by voice command. In another embodiment, the movement of the mirrors may be delayed by hysteresis so that the movement of the mirrors after an object has passed from the blind spot does not distract the operator or become an annoyance. As previously disclosed, hysterisis may be accomplished by having the mirrors move outwardly for a predetermined period of time that may be fixed, and may be contained in ECU or other controller look up tables. Moreover, the mirrors may move outwardly for an operator selected period of time, whereby the ECU or other controller has a look up table of predetermined periods of time that permit the operator to select a period of time within which the mirror will remain in an outward position before returning to an inward position. In this regard, the predetermined period of time may be a function of host vehicle speed, blind spot detection system signal strength, blind spot detection range to target, traffic intensity, turn signal status, vehicle position in a lane of travel, or any other variable. In addition, the mirror may remain in an outward position as long as an object is detected in the host vehicle's blind spot. Finally, the mirror may remain in an outward position until the operator requests, perhaps by a switch actuation, voice command, or otherwise that the mirror return from its outward position to an inward position.

FIG. 4 is a software flow chart of one method 88 to control the active mirror according to one embodiment of the present invention. Step 90 is determining whether an object is in the vehicle blind spot. This may be accomplished by the blind spot detector as described above, or can be determined during lane changing via a lane departure system as described above, or by any other detector to determine whether an object has entered a vehicle blind spot. Step 92 is activate the mirror servo mechanism and move the appropriate side mirror outwardly so that the operator can see objects in the vehicle blind spot and can visually confirm whether there is an object in the vehicle blind spot. Step 94 is move the mirror inwardly after the object is no longer detected in the vehicle blind spot. As previously stated, during mirror movements, especially in heavy traffic areas when many objects or vehicles are passing into and out of the blind spot, a hysteresis may be developed for inclusion into the algorithm controlling the mirrors so that the mirrors are delayed in returning to their inward positions until nothing is detected in the blind spot for some predetermined period of time. The implementation of a hysteresis in the movement of the mirror will serve to reduce the number of times the mirror moves inwardly and outwardly and will present a much more smooth flow of operation of the mirror, especially in high traffic situations. Step 96 is move the mirror inwardly to its resting position to restore the operator's normal field of vision after no objects are detected in the vehicle blind spot after the passage of a predetermined period of time.

While at least one embodiment of the invention has been described in the specification, those skilled in the art recognize that the words used are words of description, and not words of limitation. Many variations and modifications are possible without departing from the scope and spirit of the invention as set forth in the appended claims.

We claim:

1. A method to automatically move a side mounted mirror on a host vehicle from an inward position to an outward position in response to a signal from a detector indicative of an object outside an operator normal field of vision, comprising;
detecting whether the object is outside the normal field of vision and transmitting a data signal from said detector to a controller indicative of the presence of the object outside the normal field of vision;
actuating at least one servo mechanism responsive to a data signal from said controller to move said mirror outwardly to an outward position from said inward position to permit an operator to view said object outside the normal field of vision;
maintaining said mirror outward position for a predetermined period of time based upon hysteresis developed by said detector after said object has moved from detector;
actuating said servo mechanism responsive to a data signal from said controller to move said mirror from said outward position to return to said inward position upon expiration of said predetermined period of time and restore said normal field of vision to said operator.

2. The method of claim 1, wherein said detector is a blind spot detection system based upon cameras, radar, infrared, ultra sonic, lidar or motion detection.

3. The method of claim 1, wherein said detector is a lane departure system based upon cameras, radar, infrared or motion detection.

4. The method of claim 1, further including operator manual actuation of said mirror movements to effect movement of said mirror to show field of view outside the normal field of view to said operator and return to a normal position after a predetermined period of time.

5. The method of claim 4, further including a full active mode of operation when said operator actuates a switch; said active mode of operation comprising constantly moving said mirrors from an inward to an outward position with hysteresis to permit the operator to have a field of view outside the normal field of view.

6. The method of claim 1, further including operator voice command control of said mirror movements to effect movement of said mirror to show a field of view to said operator outside the normal field of view and return to a normal position after a predetermined period of time.

7. The method of claim 1, further including a voice command control of said mirror movements to effect movement of the mirror to permit the operator to view a field of view outside the normal field of view.

8. The method of claim 1, wherein said mirror remains in an outward position for an operator selectable predetermined period of time.

9. The method of claim 1, wherein said mirror remains in an outward position for a predetermined period of time.

10. The method of claim 9, wherein said predetermined period of time contained in a look up table in an electronic control unit (ECU) is a function of vehicle speed, blind spot detection system signal strength, blind spot detection system range to object, traffic intensity, turn signal status and vehicle position in lane of travel.

11. The method of claim 1, further including a host vehicle and another vehicle, each said vehicle equipped with a transceiver to receive signals from said other vehicle to indicate that it is in the host vehicle blind spot, thereby actuating the side view mirrors to an outward position to permit visual confirmation by the operator of the host vehicle.

12. The method of claim 1, wherein said outward position is programmable based upon specific vehicle operator input.

13. The method of claim 1, wherein the outward mirror position may be a fixed angular rotation from the inward position to permit operator viewing of the vehicle blindspot.

14. The method of claim 1, wherein the outward mirror position may be a variable angle rotation from the inward position, said angle being a function of the mirror inward position.
